(19) United States
(12) Patent Application Publication
(10) Pub. No.: US 2016/0107152 A1
(43) Pub. Date: Apr. 21, 2016

(54) METHOD FOR FORMING PHOTOCATALYST SUBSTRATE AND APPARATUS THEREOF

(71) Applicant: Aromate Industries Co., Ltd., New Taipei City (TW)

(72) Inventors: YAO-HSUAN TSENG, Taipei City (TW); CHI-CHUAN HUANG, New Taipei City (TW)

(21) Appl. No.: 14/692,712

(22) Filed: Apr. 21, 2015

(30) Foreign Application Priority Data
Oct. 17, 2014 (TW) 103135996

(51) Int. Cl. B01J 37/02; B01J 23/06; B01J 21/06; B01J 23/14

(52) U.S. Cl. CPC B01J 37/0215; B01J 37/0236; B01J 23/14; B01J 23/06; B01J 21/063

(57) ABSTRACT

A method for forming a photocatalyst substrate is disclosed, comprising the following steps. A substrate is provided. The substrate is disposed on a transporting device to transport the substrate. When the substrate is under a spray coating device, the spray coating device is used to form a photocatalyst layer on a surface of the substrate. When the substrate is under a heating device, the heating device is used to solidify the photocatalyst layer on the surface of the substrate.

### BACKGROUND OF THE INVENTION

1. Field of the Invention

The instant disclosure relates to a sol coating method; in particular, to a method for forming a photocatalyst substrate and an apparatus thereof.

2. Description of Related Art

Photocatalyst is a material which can enhance chemical reaction when irradiated by light. The most commonly used photocatalyst comprises of titanium dioxide and cadmium sulfide, wherein titanium dioxide is a preferable photocatalyst due to its preferred oxidation/reduction ability, high chemical stability and nontoxic characteristic. Photocatalyst can degrade low concentration noxious chemical substance in the air, and no noxious substance is generated therefrom. Therefore, photocatalyst is a very good material to purify environment. Photocatalyst can also provide antibacterial ability and the effect of reducing odor, disinfecting, dirt repelling and reducing noxious substance.

Titanium dioxide has three major phases, a rutile phase, an anatase phase and a brookite phase, wherein the anatase phase of titanium dioxide exhibits better photocatalytic activity. The mechanism of photocatalyst is that when photocatalyst is irradiated by a UV light or sun light, electrons and holes are generated to oxidize the substance thereon so that the substance can be degraded down into small molecules. Take titanium dioxide as an example, titanium dioxide has a band gap of about 3.2 eV. Light with wavelength of 388 nm can provide energy of about 3.2 eV, so that titanium dioxide can generate electrons and holes when irradiated by light with wavelength of 388 nm. Holes have very strong oxidation ability to directly oxidize the pollutants absorbed on the surface of the substance for disintegration purposes, or oxidize the water molecule absorbed on the surface of the substance to manufacture hydroxyl radicals. The pollutants with macromolecule are decomposed into small molecules when irradiated by light. Therefore, the goal of removing pollutants is achieved.

Although photocatalyst is widely used in various products, there is no method to effectively produce photocatalyst substrates with low cost and relative apparatus thereof. Industry needs an effective method to form photocatalyst substrates and automatic apparatus thereof.

### SUMMARY OF THE INVENTION

The objective of the instant disclosure is to provide a method for effectively forming a photocatalyst substrate and relative apparatus thereof.

In order to achieve the aforementioned objectives, according to an embodiment of the instant disclosure, a method for forming a photocatalyst substrate is disclosed. A substrate is provided. The substrate is put on a transporting device to transport the substrate. When the substrate is transported under a spray coating device, the spray coating device forms a photocatalyst layer on a surface of the substrate. When the substrate is transported under a heating device, the heating device solidifies the photocatalyst layer on the surface of the substrate.

Another embodiment provides an apparatus for fabricating a photocatalyst substrate. The apparatus comprises a transporting device, a spray coating device arranged above the transporting device, and a heating device arranged above the transporting device, and the heating device is separated from the spray coating device.

In summary, the instant disclosure provides a method for forming photocatalyst substrates and related apparatus that can fabricate photocatalyst substrates with less cost and high speed. Therefore, the photocatalyst substrates can be formed effectively and the goal of mass production of the photocatalyst substrates can be achieved.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 shows a block diagram of a method for forming a photocatalyst substrate according to an embodiment of the disclosure.

FIG. 2 shows a schematic drawing of an apparatus for fabricating a photocatalyst substrate according to an embodiment of the disclosure.

FIG. 3 shows x-ray diffraction spectrum diagram of a photocatalyst substrate fabricated by the method according to an embodiment of the disclosure.

FIG. 4 shows photocatalysis degraded acetaldehyde result of a photocatalyst substrate of an example according to the disclosure.

FIG. 5 shows photocatalysis degraded acetaldehyde result of a photocatalyst substrate of another example according to the disclosure.

### DETAILED DESCRIPTION OF THE PREFERRED EMBODIMENTS

The aforementioned illustrations and detailed descriptions are exemplary for the purpose of further explaining the scope of the instant disclosure. Other objectives and advantages related to the instant disclosure will be illustrated in the subsequent descriptions and appended drawings.

### First Embodiment

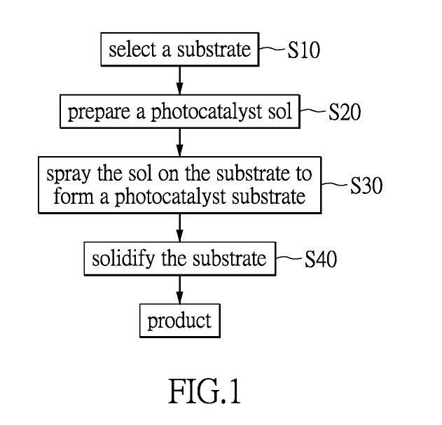

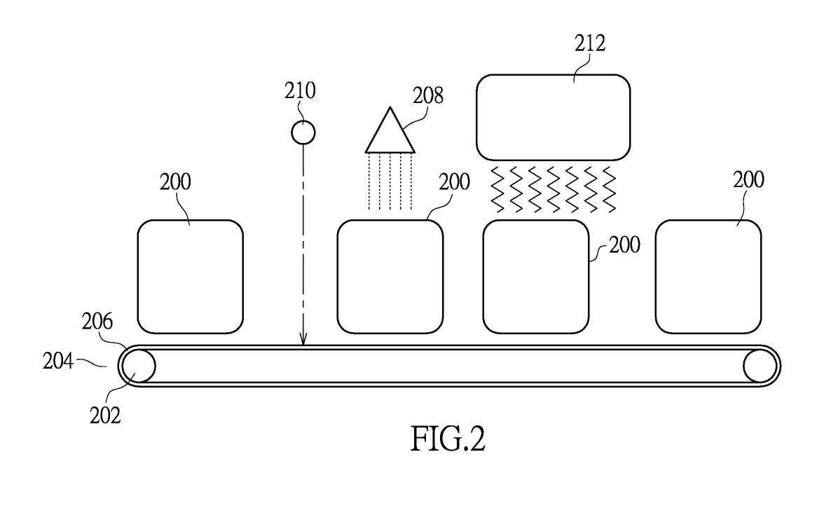

FIG. 1 shows a block diagram of a method for forming a photocatalyst substrate according to the embodiment. FIG. 2 shows a schematic drawing of an apparatus for fabricating a photocatalyst substrate. The embodiment is illustrated in accordance with FIG. 1 and FIG. 2. First, the step S10 is conducted to select a substrate 200. The embodiment is illustrated using a paper substrate as an example, but the disclosure is not limited thereto. The substrate 200 can be formed of other materials. For example, the substrate 200 can be made of textiles, plastics, wood or metals. Next, the substrate 200 is put on a transporting device 204 so that the substrate 200 can be transported. Although only one substrate 200 is described in the disclosure for simplicity, a plurality of substrate 200 are put in order on the transporting device 204 in the mass production procedure. The amount of substrates is determined according to productions or processes. The disclosure does not limit the amount of substrates.

Next, the step S20 is conducted to prepare a photocatalyst sol. Titanium dioxide, zinc oxide, tin dioxide or combinations thereof are mixed with a solvent to form a photocatalyst sol. In the embodiment, the solvent is water. The photocatalyst sol comprises of 0.01 wt %˜50 wt % of photocatalyst, and preferably comprises of 1 wt %˜10 wt % of photocatalyst. It is noted that the material for forming the photocatalyst sol is not limited to titanium dioxide, zinc oxide, tin dioxide or combinations listed above. Other materials can be mixed with solvent to form the photocatalyst sol, and the solvent is not limited to water. In the embodiment, titanium dioxide is the preferable material used for forming the photocatalyst sol, and the titanium dioxide preferably is the anatase phase. In more detail, the embodiment uses chemical coprecipitate-peptizing method to prepare the titanium dioxide sol. Titanium alkoxide and titanium tetrachloride are used as precursors to form titanium hydroxide though hydrolysis condensation followed by acid added in order to perform gel degradation. Next, a crystalling step is conducted using reflowing procedure at a temperature of about 60° C.˜100° C. to form anatase-type titanium dioxide sol. However, the disclosure is not limited to the photocatalyst water-based sol formed by this method. Other photocatalyst water-based sols can also be used in the spray coating device. An exhaustion system can further be used when forming the photocatalyst water-based sol if necessary.

Next, the step S30 is performed. The prepared photocatalyst sol is transported to a spray coating device 208. When the substrate 200 is transported under the spray coating device 208, the spray coating device 208 is used to spray the sol for coating a photocatalyst layer on a surface of the substrate 200. The spray coating device 208 can be an automatic spray gun in an embodiment. The disclosure can further install a sensing device 210 close to the spray coating device 208. When the sensing device 210 senses a substrate 200 under the spray coating device 208, a controlling device (not shown) startups the spray coating device 208 to perform a coating procedure to the substrate 200. In the embodiment, parameters of the coating step are listed as follows. The coating pressure is 1.0 bar˜2.5 bar, and the coating rate is 50 ml/min˜100 ml/min. However, the disclosure is not limited to these parameters. The parameters can vary with respect to processes or product specs. For example, if the substrate is made of plastic instead of paper, parameters of the coating steps are required to be modified, or if the substrate is made of paper of larger size, the parameters are also required to be modified. The disclosure is not limited to a specific set of coating parameters.

In addition, the disclosure can modify the moving line of the transporting device, and further increase a turnover device to flip the substrate 200 in order to coat the uncoated surface of the substrate 200. The surface of the substrate 200 is not limited to be coated only once in the disclosure. Alternatively, the surface of the substrate can be coated many times according to processes or product specs. For example, the surface of the substrate can be coated 2˜10 times.

Furthermore, the control device can control the transporting device 204, such that when the substrate 200 is transported under the spray coating device 208, the transporting device 208 stops the transporting procedure for a certain period of time. The transporting device 204 starts transporting when the spray coating device 208 finishes the coating procedure.

Thereafter, the substrate 200 is further transported by the transporting device 204, and when the substrate 200 is transported to a heating device 212, the step S40 is conducted to use the heating device 212 to solidity the photocatalyst layer on the surface of the substrate 200. The heating device 212 can includes a fan and a heater, so that the heating device 212 can send out hot air to solidify the photocatalyst layer. The heating device 212 is not limited to the type described above. The heating device 212 can be other types. For example, the heating device 212 can include but not limited to an electric heating filament, a radiator, a lamp or a high frequency heating device. The temperature of the heating step can be 20° C.˜100° C., and the duration can be 1 minute˜50 minutes. Preferably, the temperature of the heating step is 30° C.˜65° C., and the duration is 2˜15 minutes. In addition, the heating device 212 can be a tunnel-type oven, in which the length of the tunnel-type oven can be 250 cm, the transporting speed can be 15˜35 cm/min, and the temperature can be 25° C.˜85° C.

Accordingly, the photocatalyst substrate is formed after the photocatalyst layer is solidified.

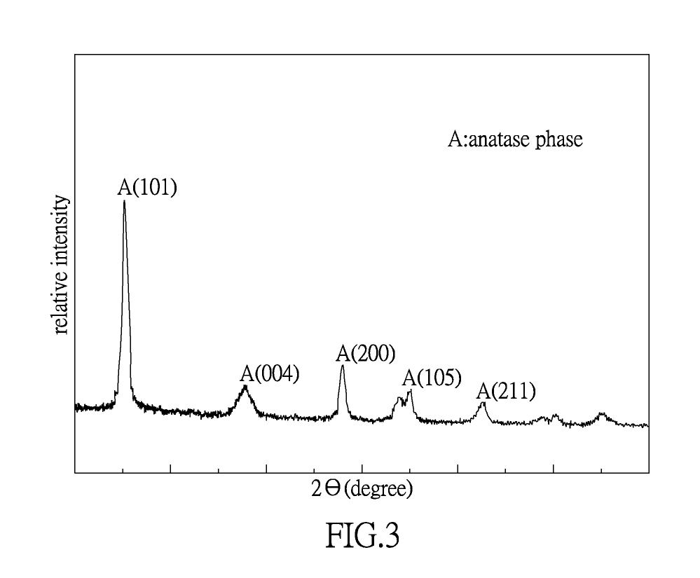

The photocatalyst substrate is analyzed by a x-ray diffraction spectrum. FIG. 3 shows the diagram with 2θ as a function of relative density, which indicate the particle size is smaller than 20 nm. Referring to FIG. 3, particle size of catalyst is 3 nm˜1 μm. Preferably, particle size of catalyst is 5 nm˜30 nm.

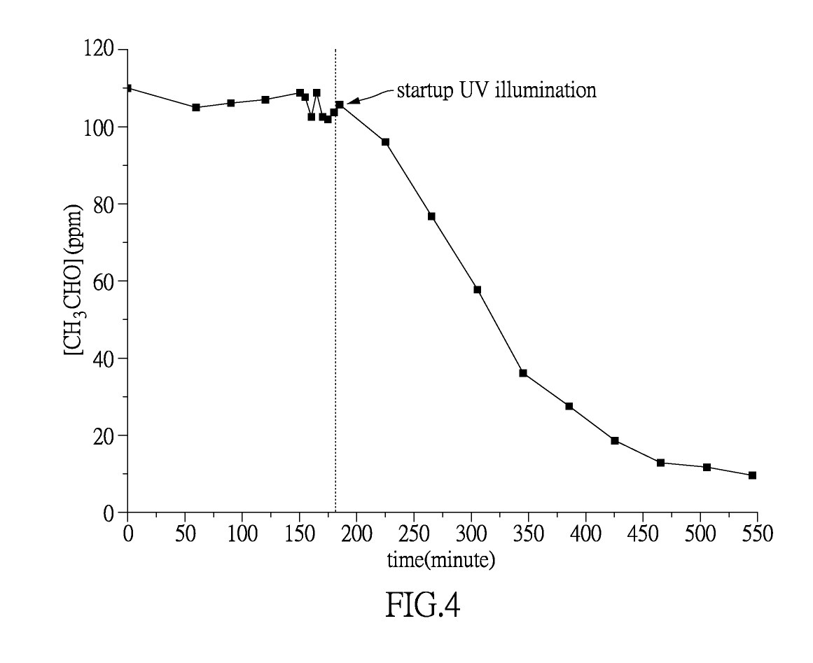

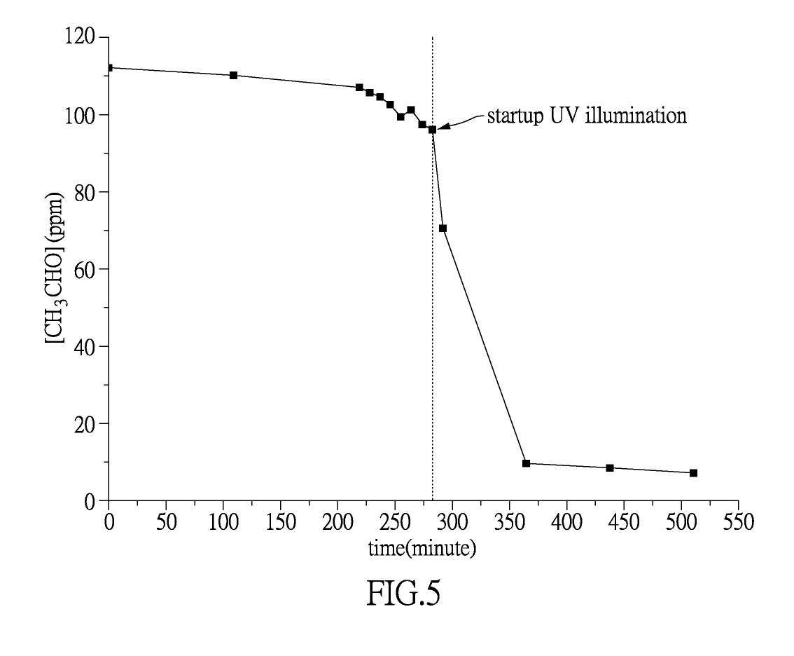

The photocatalysis degraded acetaldehyde result of the photocatalyst substrate of the embodiment is shown in FIG. 4 and FIG. 5. Referring to FIG. 4, when the paper substrate has 138 mg of titanium dioxide (photocatalyst substrate having less amount of photocatalyst) and the ultraviolet lamp is turned on at a time of 180 min, acetaldehyde is quickly degraded after 180 minutes, and the quantity of acetaldehyde is less than 20 ppm after 270 minutes of UV illumination. Referring to FIG. 5, when the paper substrate has 430 mg of titanium dioxide (photocatalyst substrate having great amount of photocatalyst) and the ultraviolet lamp is turned on at the time 160 minutes, acetaldehyde is quickly degraded after 160 minutes, and the quantity of acetaldehyde is less than 20 ppm after 40 minutes of UV illumination.

According to the testing result, the photocatalyst substrate formed by the embodiment certainly has the effect of removing pollutants in the environment.

The apparatus for forming a photocatalyst substrate according to an embodiment of the disclosure is illustrated in FIG. 2. Referring to FIG. 2, the apparatus includes a transporting device 204, in which the transporting device 204 includes a plurality of rollers 202 covered with a ribbon 206. The rollers 202 are actuated by electrical power to roll and drives the ribbon 206 to scroll, such that the substrates 200 on the ribbon 206 can be transported. A spray coating device 208 is arranged above the transporting device 204. The spray coating device 208 can be an automatic spraying gun, and can be connected to a storage device (not shown) containing photocatalyst sol. A heating device 212 is arranged above the transporting device 204 and is separated from the spray coating device 208. The heating device 212 can include an electric heating filament, a radiator, a lamp or a high frequency heating device, and can also include a fan to increase the transmission of heat. The heating device 212 can be a tunnel-type oven.

A control device (not shown) is connected to the transporting device 204, the spray coating device 208 and the heating device 212 through signal lines. The spray coating device 208 (for example automatic spraying gun) can be controlled by the control device to have a specific spraying quantity, range and/or rate. Furthermore, the control device can also control heating temperature, heating time and/or temperature rising and reducing rate of the heating device 212. In addition, the control device can control transporting speed of the transporting device 204, and can further command the transporting device 204 to stop transporting for a certain period of time when the substrates 200 thereon are coated and/or heated.

A sensing device 210 is disposed close to the spray coating device 208, and is connected to the control device through a signal line. The sensing device 210 is used to transmit a signal to the control device when the substrate 200 is being sensed. The control device then startups the spray coating device 208 to coat photocatalyst sol on the substrate 200. In an embodiment, the sensing device 210 can be at a side of the spray coating device 208 or is separated from the spray coating device 208, and a time lag can be calculated from the sensing device 210 to the spray coating device 208. When the substrate 200 is being sensed, the spray coating device 208 can start coating after the time lag. In the embodiment, the sensing device 210 is an optical sensor. However, the disclosure is not limited thereto. The sensing device 210 can be other types.

According to the description above, the method for forming photocatalyst substrates and related apparatus can fabricate photocatalyst substrates with less cost and high speed. Therefore, the photocatalyst substrates can be formed effectively and the goal of mass production of the photocatalyst substrates can be achieved.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A method for forming a photocatalyst substrate, comprising:
providing a substrate;
disposing the substrate on a transporting device to transport the substrate;
forming a photocatalyst layer on a surface of the substrate with the spray coating device when the substrate is transported under a spray coating device; and
solidifying the photocatalyst layer on the surface of the substrate with the heating device when the substrate is transported under a heating device.

2. The method for forming a photocatalyst substrate as recited in claim 1, wherein the substrate is made of paper, textile or plastic.

3. The method for forming a photocatalyst substrate as recited in claim 1, wherein the step of forming a photocatalyst layer on the surface of the substrate, further comprising:
preparing a water-based photocatalyst sol; and
coating the water-based photocatalyst sol on the surface of the substrate with the spray coating device.

4. The method for forming a photocatalyst substrate as recited in claim 3, wherein the water-based photocatalyst sol is a material selected from the group consisting of titanium dioxide, zinc oxide, tin dioxide and the combinations thereof.

5. The method for forming a photocatalyst substrate as recited in claim 3, wherein the water-based photocatalyst sol is 0.01 wt % to 50 wt % photocatalyst.

6. The method for forming a photocatalyst substrate as recited in claim 3, wherein the water-based photocatalyst sol includes water as a solvent.

7. The method for forming a photocatalyst substrate as recited in claim 3, wherein particle size of catalysts in the water-based photocatalyst sol ranges from 3 nm to 1 μm.

8. An apparatus for fabricating a photocatalyst substrate, comprises:
a transporting device;
a spray coating device arranged above the transporting device; and
a heating device arranged above the transporting device;
wherein the heating device is separated from the spray coating device.

9. The apparatus as recited in claim 8, wherein the spray coating device is an automatic spray gun.

10. The apparatus as recited in claim 8, further comprising a sensing device neighboring the spray coating device.

11. The apparatus as recited in claim 8, wherein the heating device is a tunnel-type oven.

12. The apparatus as recited in claim 8, further comprising a storage device containing a photocatalyst sol connected to the spray coating device through a pipeline.

13. The apparatus as recited in claim 8, further comprising a control device connected to the spray coating device and the heating device through signal lines.
